(19) United States
(12) Patent Application Publication
(10) Pub. No.: US 2017/0140650 A1
(43) Pub. Date: May 18, 2017

(54) METHOD, DEVICE, AND VEHICLE OF PRE-WARNING FOR A VEHICLE COLLISION

(71) Applicant: Leauto Intelligent Technology (BEIJING) Co. Ltd., Beijing (CN)

(72) Inventor: BingLin Feng, Beijing (CN)

(21) Appl. No.: 14/977,996

(22) Filed: Dec. 22, 2015

(30) Foreign Application Priority Data
Nov. 13, 2015 (CN) 201510778405.2

(51) Int. Cl. G08G 1/16; G06T 7/00; G06K 9/00; B60R 1/00; B60K 35/00

(52) U.S. Cl. CPC G08G 1/161; B60R 1/00; B60K 35/00; G06K 9/00805; G06T 7/004; B60R 2300/8093

(57) ABSTRACT

The present disclosure provides a method, device, and vehicle of pre-warning for a vehicle collision. The present disclosure may acquire two images captured by two photographing devices with respect to an obstacle; perform calculation on the two images based on close-range photogrammetry to obtain a distance between the obstacle and the rear of the vehicle; and making a pre-warning for a vehicle collision when the distance is less than a preset threshold. Because the photographing devices may utilize an inherent reversing camera of the vehicle, and avoid additionally providing an anti-knocking radar system, so that it is possible to solve the technical problem in the related art that the system cost for the anti-knocking radar system may be high, which causes difficulty in popularizing.

### CROSS-REFERENCE TO RELATED APPLICATIONS

This application is based on and claims priority to Chinese Patent Application No. 201510778405.2, with the title of “METHOD, DEVICE, AND VEHICLE OF PRE-WARNING FOR A VEHICLE COLLISION”, filed on Nov. 13, 2015, the full disclosure of which is hereby incorporated by reference in its entirety.

### TECHNICAL FIELD

The present disclosure relates to vehicle technique, and more particularly to a method, device, and vehicle of pre-warning for a vehicle collision.

### BACKGROUND

Safety in driving has always been one of the focuses in the vehicle industry. In the aspect of driving safety, as the development of electronic technology, collision pre-warning is also developed fast. In the related art, an anti-knocking radar system may be installed on some high-class vehicles, and thereby it is possible to make a pre-warning of a vehicle collision.

The anti-knocking radar system may be comprised of a plurality of sensors and a micro-computer controller, as well as a buzzer. Its principle may be as follows. The sensors transmit and receive ultra-sonic wave signals, and perform calculation according to the transmitted and received ultra-sonic wave signals by a micro-computer, so as to obtain a back and forth time of the ultra-sonic wave signals and thereby a distance to an obstacle may be measured, and then the buzzer may make alarm. However, in the related art, the system cost for the anti-knocking radar system may be high, which causes difficulty in popularizing.

### SUMMARY

The embodiments of the present disclosure provide a method, device and vehicle of pre-warning for a vehicle collision, which may solve the technical problem in the related art that the system cost for the anti-knocking radar system may be high, which causes difficulty in popularizing.

To achieve the above object, the embodiments of the present disclosure may provide the following technical solutions:

In the first aspect, the present disclosure may provide a method of pre-warning for a vehicle collision, including: acquiring two images captured by two photographing devices with respect to an obstacle; the two photographing devices may be provided at the rear of the vehicle and form an angle therebetween; the hardware parameters of the two photographing devices are same as each other; performing calculation on the two images based on close-range photogrammetry to obtain a distance between the obstacle and the rear of the vehicle; and making a pre-warning for a vehicle collision when the distance is less than a preset threshold.

In the second aspect, the present disclosure provides a device of pre-warning for a vehicle collision, including: an acquiring module configured to acquire two images captured by two photographing devices with respect to an obstacle; the two photographing devices may be provided at the rear of the vehicle and form an angle therebetween; the hardware parameters of the two photographing devices are same as each other; a calculating module configured to perform calculation on the two images based on close-range photogrammetry to obtain a distance between the obstacle and the rear of the vehicle; and a pre-warning module configured to make a pre-warning for a vehicle collision when the distance is less than a preset threshold.

In the third aspect, the present disclosure provides a vehicle, including the device of pre-warning for a vehicle collision and two photographing devices, the hardware parameters of the two photographing devices are same as each other, the two photographing devices are provided at the rear of the vehicle, and form an angle therebetween, the two photographing devices may be configured to provide images captured with respect to an obstacle.

In the fourth aspect, the present disclosure provides a device of pre-warning for a vehicle collision, comprising: one or more processors; a memory; and one or more programs stored in the memory and configured to perform operations when executed by the one or more processors, wherein the operations comprises: acquiring two images captured by two photographing devices with respect to an obstacle, wherein the two photographing devices are provided at the rear of the vehicle and form an angle therebetween, and the hardware parameters of the two photographing devices are same as each other; performing calculation on the two images based on close-range photogrammetry to obtain a distance between the obstacle and the rear of the vehicle; and making a pre-warning for a vehicle collision when the distance is less than a preset threshold.

The method, device and vehicle of pre-warning for a vehicle collision provided by the embodiments of the present disclosure may acquire two images captured by two photographing devices with respect to an obstacle; perform calculation on the two images based on close-range photogrammetry to obtain a distance between the obstacle and the rear of the vehicle; and making a pre-warning for a vehicle collision when the distance is less than a preset threshold. Because the photographing devices may utilize an inherent reversing camera of the vehicle, and avoid additionally providing an anti-knocking radar system, so that it is possible to solve the technical problem in the related art that the system cost for the anti-knocking radar system may be high, which causes difficulty in popularizing.

### BRIEF DESCRIPTION OF THE DRAWINGS

FIG. 1 is a flowchart of a method of pre-warning for a vehicle collision provided by the first embodiments of the present disclosure;

FIG. 2 is principle diagram of close-range photogrammetry;

FIG. 3 is a flowchart of another method of pre-warning for a vehicle collision provided by the second embodiments of the present disclosure;

FIG. 4 is a structural diagram of a device of pre-warning for a vehicle collision provided by the third embodiments of the present disclosure;

FIG. 5 is a structural diagram of another device of pre-warning for a vehicle collision provided by the first embodiments of the present disclosure;

FIG. 6 is a schematic diagram of a vehicle; and

FIG. 7 is a structural diagram of another device of pre-warning for a vehicle collision provided by the first embodiments of the present disclosure.

### DESCRIPTION OF THE EMBODIMENTS

In the following, detailed description may be made on the method, device and vehicle of pre-warning for a vehicle collision of the embodiments of the present disclosure in connection with drawings.

### First Embodiment

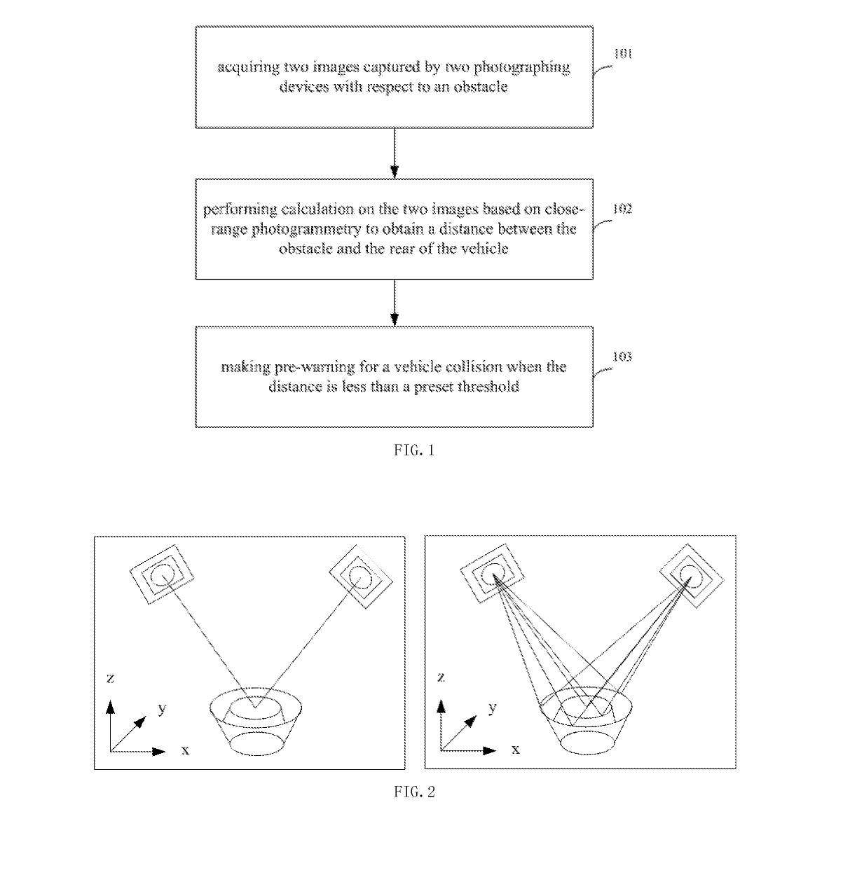

FIG. 1 is a flowchart of a method of pre-warning for a vehicle collision provided by the first embodiments of the present disclosure. As shown in FIG. 1, the method may include:

Step 101, acquiring two images captured by two photographing devices with respect to an obstacle, wherein the two photographing devices may be provided at the rear of the vehicle and form an angle therebetween; the hardware parameters of the two photographing devices are same as each other and the hardware parameters may include aperture and/or focal length.

Step 102, performing calculation on the two images based on close-range photogrammetry to obtain a distance between the obstacle and the rear of the vehicle.

More particularly, the close-range photogrammetry may refer to the photogrammetry performed with respect to a pair of stereoscopic images captured with repsect to an object with an object distance equal to or less than 300 m. The close-range photogrammetry was invented originally with an intention to improve the productivity and quality of products on the production line of steel rolling. FIG. 2 is principle diagram of close-range photogrammetry. As shown in FIG. 2, a close-range photogrammetry method may include installing measuring cameras, measuring the size and shape of the subject to be processed in real-time, and guiding the device to process the billet. Therefore, in a close range, generally in a range of 100 m, object images may be captured and its size, shape and geometry position may be determined by processing the object images. The detailed calculation may refer to the descriptions in books related to the measure principle, and may be omitted in the present embodiment.

S103, making a pre-warning for a vehicle collision when the distance is less than a preset threshold.

In the related art, the anti-knocking radar system is high in price and thus may be equipped only on high-class vehicles but not on middle-class and low-class vehicles. However, by using close-range photogrammetry, the measuring for distance may be implemented only with the hardware of two photographing devices, which may be two regular reversing camera of the same type. That is to say, there is no need to use professional cameras, which may reduce the cost greatly and be acceptable to most users.

The present embodiment may acquire two images captured by two photographing devices with respect to an obstacle; perform calculation on the two images based on close-range photogrammetry to obtain a distance between the obstacle and the rear of the vehicle; and making a pre-warning for a vehicle collision when the distance is less than a preset threshold. Because the photographing devices may utilize an inherent reversing camera of the vehicle, and avoid additionally providing an anti-knocking radar system, so that it is possible to solve the technical problem in the related art that the system cost for the anti-knocking radar system may be high, which causes difficulty in popularizing.

### Second Embodiment

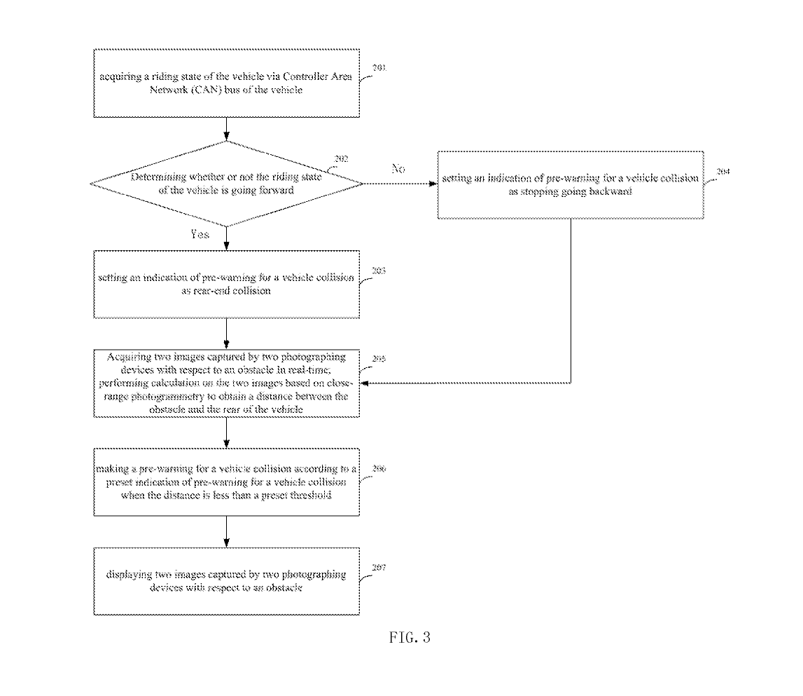

FIG. 3 is a flowchart of another method of pre-warning for a vehicle collision provided by the second embodiments of the present disclosure. As shown in FIG. 3, the method includes:

Step 201, acquiring a riding state of the vehicle via Controller Area Network (CAN) bus of the vehicle, wherein the riding state may be going forward or going backward.

More particularly, when the riding state of a vehicle changes, the current riding state of the vehicle may be acquired via the CAN bus of the vehicle.

Step 202, determining whether or not the riding state of the vehicle is going forward, and if so, step 203 may be performed, and otherwise, step 204 may be performed.

Step 203, setting an indication of pre-warning for a vehicle collision as rear-end collision.

More particularly, if the riding state is going forward and there is an obstacle behind, it may be determined that a rear-end collision is going to happen. Therefore, when the vehicle is going forward, the indication of pre-warning for a vehicle collision may be set as rear-end collision.

Step 204, setting an indication of pre-warning for a vehicle collision as stopping going backward.

More particularly, the indication being set may be a sound indication, and may be a displayed sign or text for indication.

Step 205, acquiring two images captured by two photographing devices with respect to an obstacle; performing calculation on the two images based on close-range photogrammetry to obtain a distance between the obstacle and the rear of the vehicle.

Step 206, making a pre-warning for a vehicle collision according to a preset indication of pre-warning for a vehicle collision when the distance is less than a preset threshold.

More particularly, when the riding state is going forward and a distance to the obstacle is less than a preset threshold, an indication for read-end collision may be made; and when the riding state is going backward and a distance to the obstacle is less than a preset threshold, an indication for stopping going backward may be made.

Step 207, displaying two images captured by two photographing devices with respect to an obstacle.

More particularly, the two images may be displayed on a display inside the vehicle for the user's reference.

The present embodiment may acquire two images captured by two photographing devices with respect to an obstacle; perform calculation on the two images based on close-range photogrammetry to obtain a distance between the obstacle and the rear of the vehicle; and making a pre-warning for a vehicle collision when the distance is less than a preset threshold. Because the photographing devices may utilize an inherent reversing camera of the vehicle, and avoid additionally providing an anti-knocking radar system, so that it is possible to solve the technical problem in the related art that the system cost for the anti-knocking radar system may be high, which causes difficulty in popularizing.

### Third Embodiment

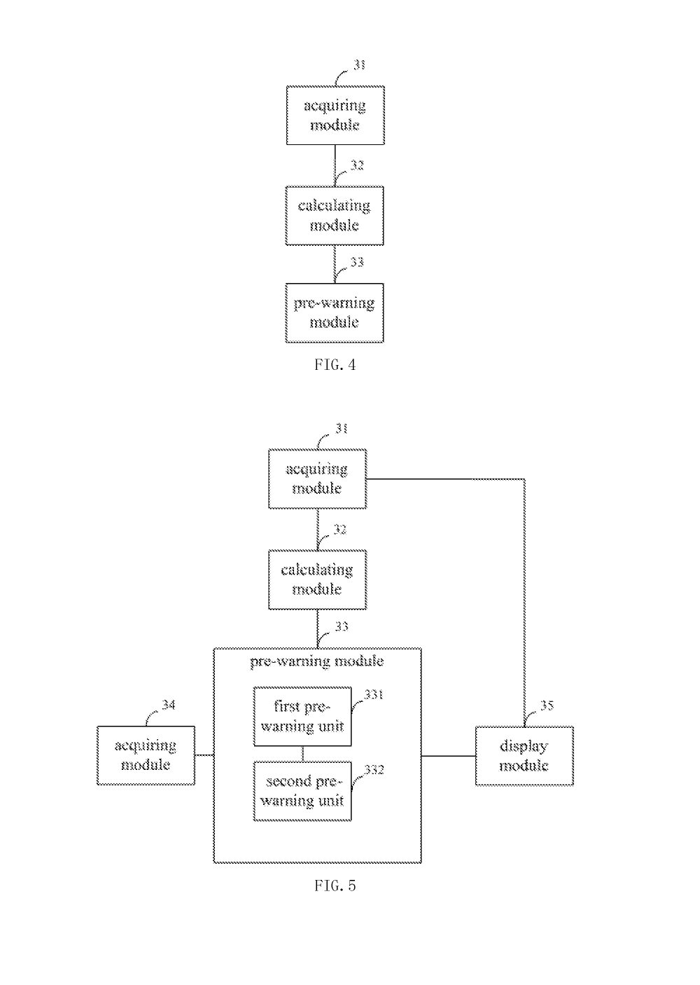

FIG. 4 is a structural diagram of a device of pre-warning for a vehicle collision provided by the third embodiments of the present disclosure. As shown in FIG. 4, the device may include: an acquiring module 31, a calculating module 32, and a pre-warning module 33.

The acquiring module 31 may be configured to acquire two images captured by two photographing devices with respect to an obstacle. The two photographing devices may be provided at the rear of the vehicle and form an angle therebetween. The hardware parameters of the two photographing devices are same as each other.

The calculating module 32 may be connected with the acquiring module 31, and may be configured to perform calculation on the two images based on close-range photogrammetry to obtain a distance between the obstacle and the rear of the vehicle.

The pre-warning module 33 may be connected with the calculating module 32 and may be configured to make a pre-warning for a vehicle collision when the distance is less than a preset threshold.

The present embodiment may acquire two images captured by two photographing devices with respect to an obstacle; perform calculation on the two images based on close-range photogrammetry to obtain a distance between the obstacle and the rear of the vehicle; and making a pre-warning for a vehicle collision when the distance is less than a preset threshold. Because the photographing devices may utilize an inherent reversing camera of the vehicle, and avoid additionally providing an anti-knocking radar system, so that it is possible to solve the technical problem in the related art that the system cost for the anti-knocking radar system may be high, which causes difficulty in popularizing.

### Fourth Embodiment

FIG. 5 is a structural diagram of another device of pre-warning for a vehicle collision provided by the first embodiments of the present disclosure. As shown in FIG. 5, on the basis of the foregoing embodiment, the device of pre-warning for a vehicle collision in the present embodiment may further include: an acquiring module 34.

The acquiring module 34 may be connected with the pre-warning module 33 and may be configured to acquire a riding state of the vehicle via Controller Area Network (CAN) bus of the vehicle, wherein the riding state may be going forward or going backward.

Therefore, the pre-warning module 33 may further include: a first pre-warning unit 331 and a second pre-warning unit 332.

The first pre-warning unit 331 may be configured to issue the indication of rear-end collision to the user if the riding state is going forward and the distance is less than a preset threshold.

The second pre-warning unit 332 may be connected with the first pre-warning unit 331 and may be configured to issue the indication of stopping going backward to the user if the riding state is going backward and the distance is less than a preset threshold.

Furthermore, the device of pre-warning for a vehicle collision may further include a display module 35.

The display module 35 may be connected with the acquiring module 31 and the pre-warning module 33, and configured to display two images captured by two photographing devices with respect to an obstacle.

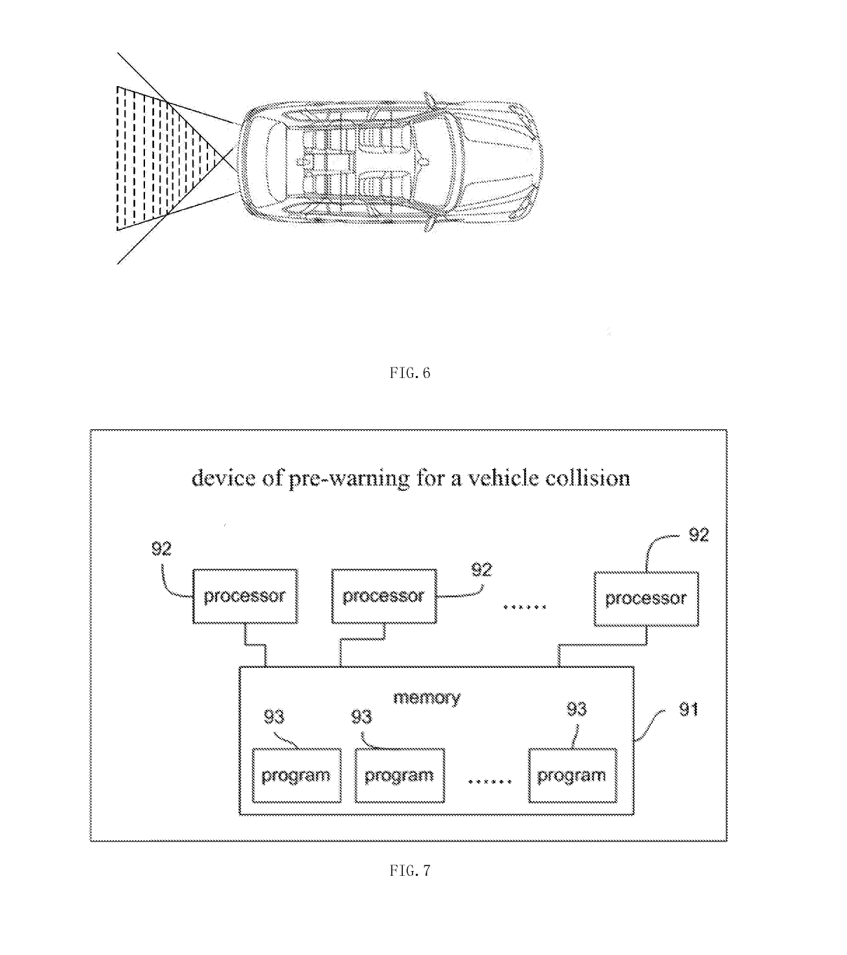

The present disclosure may further provide a vehicle including the device of pre-warning for a vehicle collision provided by the third or fourth embodiment and two cameras. FIG. 6 is a schematic diagram of a vehicle. As shown in FIG. 6, the two regions of fan-shape in FIG. 6 may be the photographing region of the two cameras respectively. The overlapping area of the two photographing regions, i.e., the area filled with dashed lines, may be an effective area. When an obstacle is in the effective area, a pre-warning for a vehicle collision may be made.

More particularly, the hardware parameters of the two photographing devices are same as each other, are provided at the rear of the vehicle, and form an angle therebetween. The hardware parameters may include aperture and/or focal length.

The two photographing devices may be configured to provide images captured with respect to an obstacle.

More particularly, the two photographing devices may utilize an inherent reversing camera of the vehicle. In the related art, the anti-knocking radar system is high in price and thus may be equipped only on high-class vehicles but not on middle-class and low-class vehicles. However, by using close-range photogrammetry, the measuring for distance may be implemented only with the hardware of two photographing devices, which may be two regular reversing camera of the same type. That is to say, there is no need to use professional cameras, which may reduce the cost greatly and be acceptable to most users.

The present embodiment may acquire two images captured by two photographing devices with respect to an obstacle; perform calculation on the two images based on close-range photogrammetry to obtain a distance between the obstacle and the rear of the vehicle; and making a pre-warning for a vehicle collision when the distance is less than a preset threshold. Because the photographing devices may utilize an inherent reversing camera of the vehicle, and avoid additionally providing an anti-knocking radar system, so that it is possible to solve the technical problem in the related art that the system cost for the anti-knocking radar system may be high, which causes difficulty in popularizing.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, and the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method of pre-warning for a vehicle collision, comprising:
acquiring two images captured by two photographing devices with respect to an obstacle, wherein the two photographing devices are provided at the rear of the vehicle and form an angle therebetween, and the hardware parameters of the two photographing devices are same as each other;
performing calculation on the two images based on close-range photogrammetry to obtain a distance between the obstacle and the rear of the vehicle; and
making a pre-warning for a vehicle collision when the distance is less than a preset threshold.

2. The method of pre-warning for a vehicle collision according to claim 1, wherein before the making a pre-warning for a vehicle collision when the distance is less than a preset threshold, the method further comprises:
acquiring a riding state of the vehicle via Controller Area Network (CAN) bus of the vehicle, wherein the riding state may be going forward or going backward; and
the making a pre-warning for a vehicle collision when the distance is less than a preset threshold comprises:
making an indication for read-end collision, when the riding state is going forward and a distance to the obstacle is less than a preset threshold, and
making an indication for stopping going backward, when the riding state is going backward and a distance to the obstacle is less than a preset threshold.

3. The method of pre-warning for a vehicle collision according to claim 1, wherein after the making a pre-warning for a vehicle collision when the distance is less than a preset threshold, the method further comprises:
displaying two images captured by two photographing devices with respect to an obstacle.

4. The method of pre-warning for a vehicle collision according to claim 2, wherein after the making a pre-warning for a vehicle collision when the distance is less than a preset threshold, the method further comprises:
displaying two images captured by two photographing devices with respect to an obstacle.

5. The method of pre-warning for a vehicle collision according to claim 1, wherein the hardware parameters comprise aperture and/or focal length, and the photographing devices are reversing cameras of the vehicle.

6. The method of pre-warning for a vehicle collision according to claim 2, wherein the hardware parameters comprise aperture and/or focal length, and the photographing devices are reversing cameras of the vehicle

7. A device of pre-warning for a vehicle collision, comprising:
one or more processors;
a memory; and
one or more programs stored in the memory and configured to perform operations when executed by the one or more processors, wherein the operations comprise:
acquiring two images captured by two photographing devices with respect to an obstacle, wherein the two photographing devices are provided at the rear of the vehicle and form an angle therebetween, and the hardware parameters of the two photographing devices are same as each other;
performing calculation on the two images based on close-range photogrammetry to obtain a distance between the obstacle and the rear of the vehicle; and
making a pre-warning for a vehicle collision when the distance is less than a preset threshold.

8. The device of pre-warning for a vehicle collision according to claim 7, wherein before the making a pre-warning for a vehicle collision when the distance is less than a preset threshold, the operations further comprise:
acquiring a riding state of the vehicle via Controller Area Network (CAN) bus of the vehicle, wherein the riding state may be going forward or going backward; and
the making a pre-warning for a vehicle collision when the distance is less than a preset threshold comprises:
making an indication for read-end collision, when the riding state is going forward and a distance to the obstacle is less than a preset threshold, and
making an indication for stopping going backward, when the riding state is going backward and a distance to the obstacle is less than a preset threshold..

9. The device of pre-warning for a vehicle collision according to claim 7, wherein after the making a pre-warning for a vehicle collision when the distance is less than a preset threshold, the operations further comprise:
displaying two images captured by two photographing devices with respect to an obstacle.

10. The device of pre-warning for a vehicle collision according to claim 8, wherein after the making a pre-warning for a vehicle collision when the distance is less than a preset threshold, the operations further comprise:
displaying two images captured by two photographing devices with respect to an obstacle.

11. The device of pre-warning for a vehicle collision according to claim 7, wherein the hardware parameters comprise aperture and/or focal length, and the photographing devices are reversing cameras of the vehicle.

12. The device of pre-warning for a vehicle collision according to claim 8, wherein the hardware parameters comprise aperture and/or focal length, and the photographing devices are reversing cameras of the vehicle.

13. A vehicle, comprising the device of pre-warning for a vehicle collision according to claim 7 and two photographing devices, wherein the hardware parameters of the two photographing devices are same as each other, and the two photographing devices are provided at the rear of the vehicle, and form an angle therebetween, and
the two photographing devices are configured to provide images captured with respect to an obstacle to the device of pre-warning for a vehicle collision.

14. A vehicle, comprising the device of pre-warning for a vehicle collision according to claim 8 and two photographing devices, wherein the hardware parameters of the two photographing devices are same as each other, and the two photographing devices are provided at the rear of the vehicle, and form an angle therebetween, and
the two photographing devices are configured to provide images captured with respect to an obstacle to the device of pre-warning for a vehicle collision.

15. A vehicle, comprising the device of pre-warning for a vehicle collision according to claim 9 and two photographing devices, wherein the hardware parameters of the two photographing devices are same as each other, and the two photographing devices are provided at the rear of the vehicle, and form an angle therebetween, and
the two photographing devices are configured to provide images captured with respect to an obstacle to the device of pre-warning for a vehicle collision.

16. A vehicle, comprising the device of pre-warning for a vehicle collision according to claim 10 and two photographing devices, wherein the hardware parameters of the two photographing devices are same as each other, and the two photographing devices are provided at the rear of the vehicle, and form an angle therebetween, and
the two photographing devices are configured to provide images captured with respect to an obstacle to the device of pre-warning for a vehicle collision.

17. A vehicle, comprising the device of pre-warning for a vehicle collision according to claim 11 and two photographing devices, wherein the hardware parameters of the two photographing devices are same as each other, and the two photographing devices are provided at the rear of the vehicle, and form an angle therebetween, and
the two photographing devices are configured to provide images captured with respect to an obstacle to the device of pre-warning for a vehicle collision.

18. A vehicle, comprising the device of pre-warning for a vehicle collision according to claim 12 and two photographing devices, wherein the hardware parameters of the two photographing devices are same as each other, and the two photographing devices are provided at the rear of the vehicle, and form an angle therebetween, and
the two photographing devices are configured to provide images captured with respect to an obstacle to the device of pre-warning for a vehicle collision.
